(19) United States
(12) Patent Application Publication
(10) Pub. No.: US 2005/0108296 A1
(43) Pub. Date: May 19, 2005

(54) File system preventing file fragmentation

(76) Inventors: Takaki Nakamura, Kokubunji (JP); Kenzo Moriyama, Fujisawa (JP); Toshiaki Mori, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/834,837

(22) Filed: Apr. 30, 2004

(30) Foreign Application Priority Data
Oct. 30, 2003 (JP) 2003-369816

(51) Int. Cl. G06F 12/00

(52) U.S. Cl. 707/200

(57) ABSTRACT

In a file system capable of reserving a storage area, disk fragments can be prevented and an insufficient file system area is hard to occur. A response time of writing a small size file can be shortened. When a file is written, a file size is compared with a plurality of preset threshold values and reservation is executed at a reservation size corresponding to the file size. If the reservation is failed due to an insufficient file system capacity, the reservation is again executed at an actual I/O size to effectively use the file system area. If the file size does not reach the preset smallest threshold value, the reservation is again executed at the actual I/O size and the reservation release process for the file equal to or smaller than the smallest threshold value is skipped.

The present application claims priority from Japanese application JP2003-369816 filed on Oct. 30, 2003, the content of which is hereby incorporated by reference into this application.

### BACKGROUND OF THE INVENTION

1. Field of the Invention

The present invention relates to a method of preventing disk fragmentation in a file system capable of reserving a disk storage area.

2. Description of the Related Art

In a conventional file system of UNIX (registered trademark) origin, a file is divided into metadata (inode) which is file management information and user data which is the actual contents of the file. The user data is managed in the unit of a file system block size (e.g., 4 KB). The metadata has a mapping table in order to manage the block position where the user data is stored, the mapping table indicating the correspondence between a file offset and a file system block number. In the conventional file system, the mapping table stores an array of file system block numbers, and the main trend is the block management algorithm wherein as the file offset becomes larger, reference to the block number becomes more indirect.

The block management algorithm will be described by using an example shown in FIG. 2. In the block management algorithm, a mapping table 201 is stored as a portion of the inode information of a file. The block numbers indicating user data positions are stored in top several entries of the table. The block number of the first entry indicates the data having a file offset of 0, and the block number in the second entry indicates the data having a file offset of 4 KB. Since the mapping table 201 has a fixed size which cannot be made too large, the last three entries do not directly indicate the user data position but indirectly indicates the block number of the user data position. A first indirect reference block number of the mapping table 201 indicates a first indirect reference table 202a whose entries store the block numbers of user data. A second indirect reference block number of the mapping table 201 indicates a second indirect reference table 203a whose entries store first indirect reference block numbers indicating first indirect reference tables 202b, 202c, . . . . A third indirect reference block number of the mapping table 201 indicates a third indirect reference table 204a. The entries of the third indirect reference table 204a store second indirect reference block numbers indicating second indirect reference tables 203b, 203c, . . . . The first indirect reference tables 202b to 202g have the same function as that of the first indirect reference table 202a, and the second indirect reference tables 203b and 203c have the same function as that of the second indirect reference table 203a. For example, the EXT2 file system of Linux has fifteen entries in the inode, the first twelve entries directly point the block numbers and the remaining three entries point the first, second and third indirect reference block numbers.

As the disks, file systems or files have had recently a large capacity, the above-described block management algorithm is becoming to have a limit to the file size to be dealt with and to its performance. Instead of managing mapping information of the relation between the file offset and block in one-to-one correspondence for each block size as in the case of the block management algorithm, a current general tendency is to use an extent method which manages the information of a start file offset, a start block number and a block length, as shown in FIG. 3. The extent method not only manages files by using a single table in the inode such as shown in FIG. 3, but also manages files hierarchically using B-Tree or the like. File systems adopting the extent method are JFS (IBM), XFS (SGI), VxFS (VERITAS) and the like.

If a continuous area of a disk can be allocated, the extent method can express mapping between the user data and disk positions with a small number of entries and is very effective for large scale files. The continuous area cannot always be allocated because the continuous area may be already allocated to another file or because of other reasons. The state that block positions of a disk allocated to one file are dispersed, is called an external fragment.

When fragment occurs in the file system of the extent method, not only the performance is degraded, but also the mapping table becomes bulky. As the mapping table becomes bulky, an insufficient memory is likely to occur, which causes an unstable OS (deadlock, slowdown, panic).

In order to prevent fragments, the following measures are used, for example, in XFS.
(1) An asynchronous Write system call adopts a Delaying Allocation scheme in which only a block area (size) is reserved, and when data is actually written in a disk, the block number is determined. It is possible to delay the determination of a block number to an ultimate time and extent coupling can be expected.
(2) When the block area is reserved, the block area is reserved (64 KB) larger than an actual I/O request length to thereby ensure that the reservation length is always continuous.
(3) Releasing the unused area of the area reserved largely is performed in the extension of Close.

Fragments in local accesses can be prevented fairly by the above-described measures. For accesses via NFS, irrespective of the size of an I/O request at an NFS client, the request is divided during the process of network packet assembly so that the I/O length at the server becomes eventually about 4 kB to 8 KB. For Write accesses via NFS, the procedure of Open→Write (4 KB-8 KB, both asynchronous and synchronous)→Fsync (write guarantee)→Close is repeated and a disk write per one I/O occurs so that the effects (1) are not expected.

For accesses via NFS, the reservation is released every 4 KB to 8 KB for (3). This becomes a critical issue in reserving a continuous area. Therefore, the following measure is additionally used.
(4) For Write accesses via NFS, data is registered in a cache, and the unused area is not released during Close so long as the data is being registered in the cache.

If (4) functions in a valid manner, fragments are about the reserved size (64 KB) (2) at the worst.

In XFS, 16 bytes are used for one extent entry. If a file of 1 TB is fragmented at 64 KB, the capacity of a mapping table is 256 MB. A current high end NAS system has a storage capacity over 100 TB and a main memory of several GB. Therefore, if the fragmented file of several TB is accessed at the same time, an insufficient memory is likely to occur.

VxFS of the VERITAS Corporation adopts the algorithm which reserves the area twice as large as the current file size when an additional extent is acquired. Although this scheme can fairly prevent fragments, it has the demerit that the area is reserved too much, and file system full is likely to occur.

In order to prevent fragments in conventional file systems, there is a tradeoff that file system full is likely to occur. If the area is reserved largely, it is obvious that the unused area is required to be released. This process cost is required to be paid attention.

Japanese Patent Application JP-A-8-115238 diskloses the techniques that a plurality of storage areas having a plurality of different sizes are duplicatedly reserved, and when actual data is to be stored, the storage area having a proper size is selected. In this manner, data is prevented from being stored in the reserved area which is unnecessarily large, preventing fragments (file fragmentation) more or less. However, when the storage device has no marginal area, reservation itself of a plurality of areas becomes difficult and the initial effects cannot be obtained. There is another problem that the cost of a reserved area release process increases.

### SUMMARY OF THE INVENTION

A conventional file system is difficult to satisfy both fragment prevention and file system full hardship. The present invention therefore addresses an issue of realizing a file system capable of both fragment prevention and file system full hardship. The invention also addresses an issue of reducing a release cost for an unnecessary area in a small scale file system.

The above-described issues can be solved by the invention by changing an area reservation policy and area reservation size in accordance with a file size. Specifically, for a small size file, reservation is performed at the actual I/O request length, for a file of a middle size or larger, reservation is performed at a reservation size designated in advance in accordance with the file size. When an area of a middle size or larger is reserved, if the reservation fails due to an insufficient empty capacity of the file system, reservation is tried at the read I/O request length to thereby make file system full difficult to occur. For a small size file, reservation is performed at the actual I/O request and the reserved area release process is not performed to improve the I/O response of the small size file.

According to the invention, the reservation size is changed with the file size. It is therefore possible to realize a file system capably of preventing disk fragments and making difficult an insufficient file system capacity to occur by considering the failure of reservation of a whole file or at a large size

For the small size file, reservation is performed at the request I/O size. It is therefore possible to skip the reservation release process for the small size and to improve the response of generating and writing a small size file.

Other objects, features and advantages of the invention will become apparent from the following description of the embodiments of the invention taken in conjunction with the accompanying drawings.

### BRIEF DESCRIPTION OF THE DRAWINGS

FIG. 1 is a flow chart illustrating an area reservation process during a Write process according to an embodiment of the present invention.

FIG. 2 is a block diagram showing the contents of a mapping table used by a block management method of a conventional file system.

FIG. 3 is a block diagram showing the contents of a mapping table used by an extent method of a conventional file system.

FIG. 4 is a block diagram showing the outline of a file system according to an embodiment of the invention.

FIG. 5 is a flow chart illustrating a release process for an unused reservation area during a Close process according to an embodiment of the invention.

FIG. 6 is a block diagram of an interface between a kernel and a user to be used when parameters used by reservation size judgement conditions are set and referred, according to an embodiment of the invention.

FIG. 7 is a diagram showing the structure of an information processing apparatus installing the file system of this invention.

### DESCRIPTION OF THE EMBODIMENTS

Embodiments of the invention will be described with reference to the accompanying drawings.

FIG. 4 is a block diagram showing the configuration of a file system according to an embodiment of the invention. Only those pertinent to the invention are drawn in this block diagram.

When a Write system call is issued, the control is passed to a Write processing unit 400. The Write processing unit 400 sends a reservation request to an area reservation release managing unit 420, by using a reservation size determined by an area reservation issuing unit 401.

If the reservation succeeds, a buffer generating unit 402 generates a buffer, and an I/O issuing unit 403 prepares for an I/O issuance. If an asynchronous I/O is used, the control is passed to a queue capable of issuing an I/O to terminate the Write system call. If a synchronous I/O is used, an I/O is issued and its completion is awaited. After the normal completion is confirmed, the Write system call is terminated.

Next, a reservation release process will be described. When a Close system call is issued, the control is passed to a Close processing unit 410 in the kernel space. The Close processing unit 410 determines whether a reservation area release determining unit 411 executes the release process. If it is determined that the release process is executed, the area reservation release managing unit 420 is requested to execute a release process for an unused area of the reserved area. A resource releasing unit 412 executes the release process for a file descriptor and the like. In this embodiment, although the reserved area is released in the extension of the Close system call, the reserved area may be released in the extension of an Umount system call or in the extension of discard of the inode on a memory.

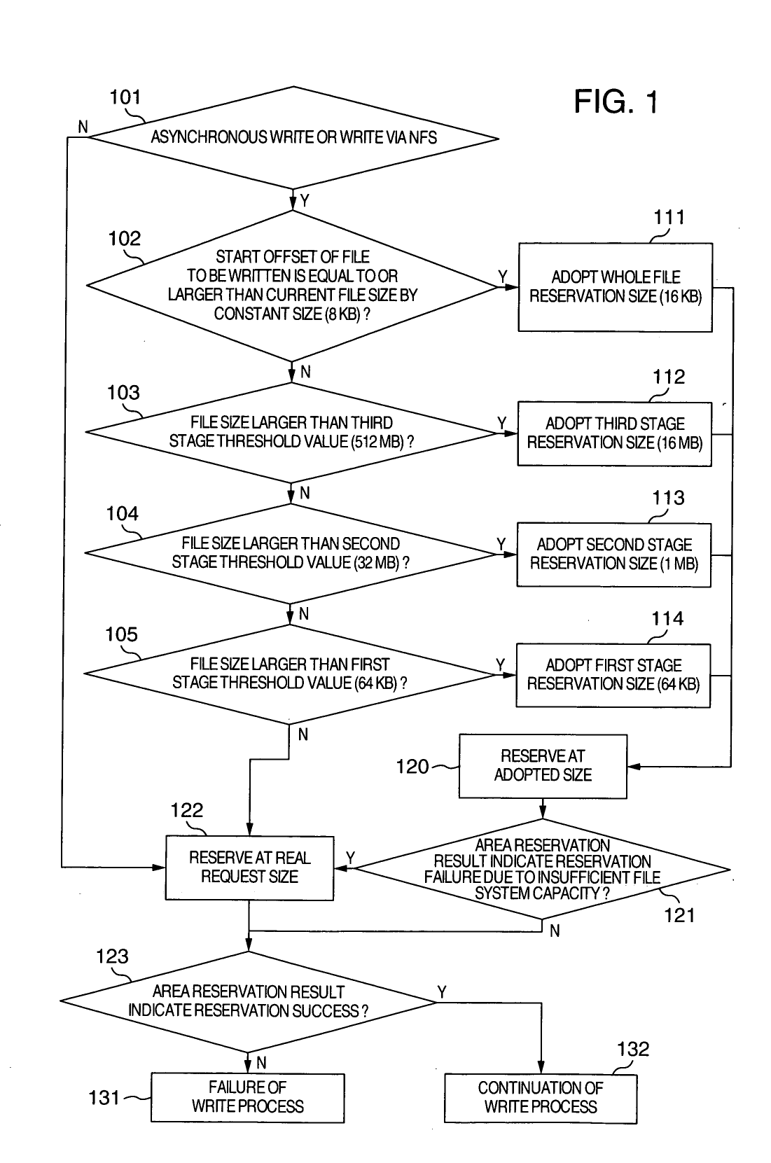

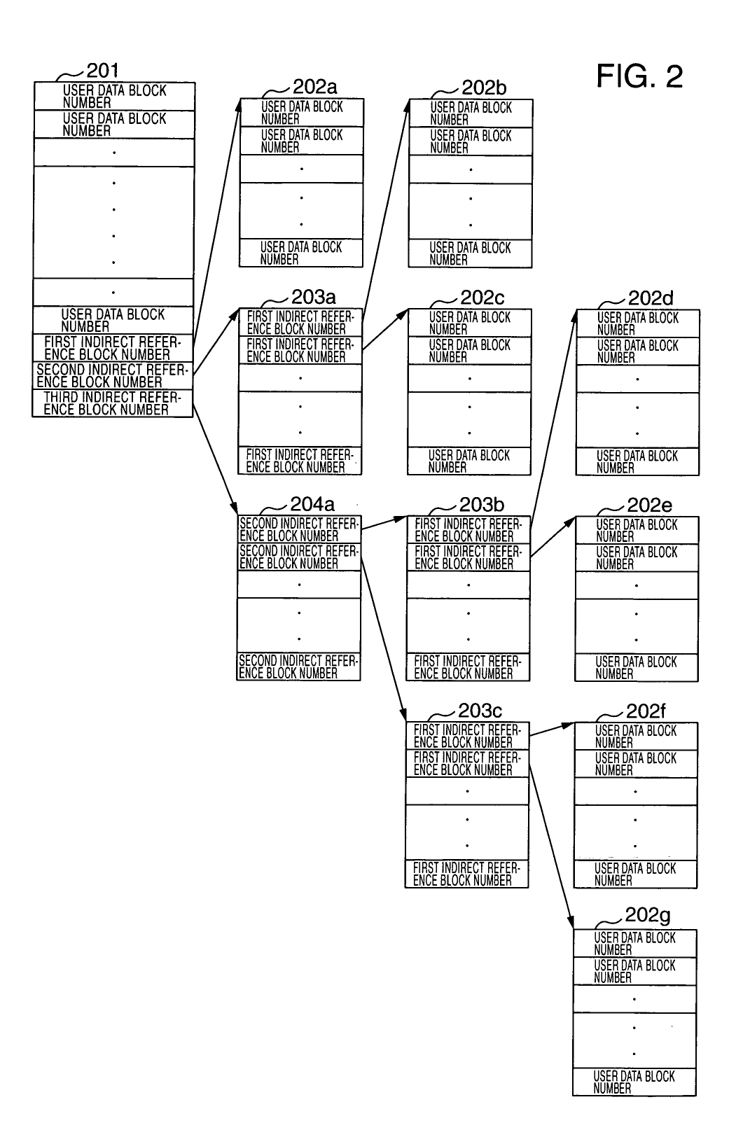

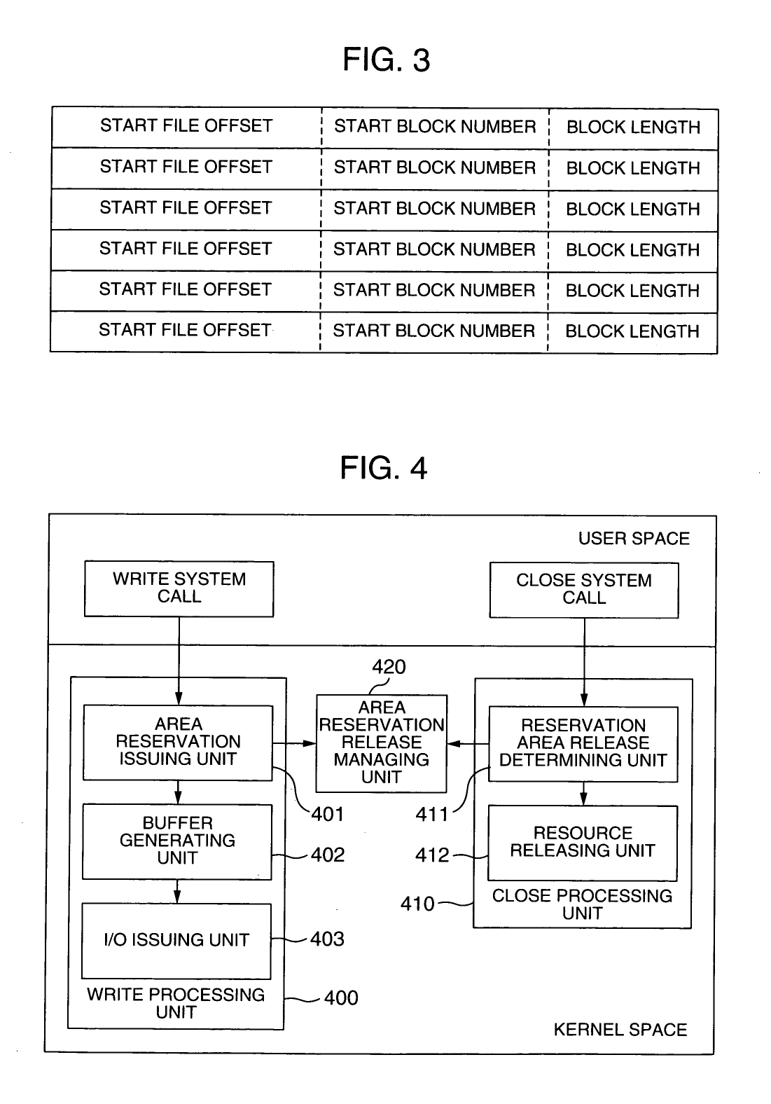

Next, with reference to FIG. 1, detailed description will be made on the contents of the procedure to be executed by the area reservation issuing unit 401 shown in FIG. 4. First, at 101 it is judged whether the Write system call is an asynchronous Write or a synchronous Write via NFS. If this condition is not satisfied, the process at 122 is executed.

At 102 it is judged whether the start offset of a file descriptor of the file to be written is larger than a sum of a current file size and a whole file judgement threshold value (e.g., 8 KB).

If the start offset is equal to or lager than the sum, a whole file reserved size (e.g., 16 KB) at 111 is adopted. In addition to this embodiment adopting the whole file reserved size, other embodiments are conceivable which adopt immediately the real request size at 122 or a first stage reservation size at 114.

If the start offset is smaller than the sum, the process at 103 follows. At 103 it is judged whether the file size is larger than a third stage threshold value (e.g., 512 MB). If the file size is equal to or large than the third stage threshold value, a third stage reservation size (e.g., 16 MB) at 112 is adopted.

If the file size is not large than the third stage threshold value, the process at 104 follows. At 104 it is judged whether the file size is larger than a second stage threshold value (e.g., 32 MB). If the file size is equal to or larger than the second stage threshold value, a second stage reservation size (e.g., 1 MB) at 113 is adopted.

If the file size is not larger than the second stage threshold value, the process at 105 follows. At 105 it is judged whether the file size is larger than a first stage threshold value (e.g., 64 KB). If the file size is equal to or larger than the first stage threshold value, a first stage reservation size (e.g., 64 KB) at 114 is adopted.

In this embodiment, although the first stage threshold value, second stage threshold value and third stage threshold value are compared with the file size, another embodiment is conceivable which uses a file offset as the comparison object.

If all the conditions 102 to 105 are not satisfied, at 122 the reservation request is issued to the area reservation release managing unit 420, by using an actual I/O size. If any one of the conditions 111 to 114 are satisfied, at 120 the reservation request is issued to the area reservation release managing unit 420, by using respective adopted reservation sizes. At 121 it is checked whether the area reservation fails because of an insufficient file system capacity. If the area reservation fails because of an insufficient file system capacity, at 122 reservation is performed again at the actual I/O request size. If the condition at 121 is not satisfied, namely, if the reservation succeeds or fails due to the reason other than the insufficient file system capacity, a process at 123 follows. After the process at 122 is executed, the process at 123 also follows.

At 123 it is checked whether the area reservation result is a reservation success. If the reservation succeeds, a Write process continues at 132 and the control is passed to the buffer generating unit 402. If the reservation fails, the Write process fails at 131 and an error is notified to a user program.

In this embodiment, although the file size judgement is executed at three stages, the number of stages may be arbitrary. The first stage threshold value may be set to 0. In this case, the process will not transit from 105 to 122.

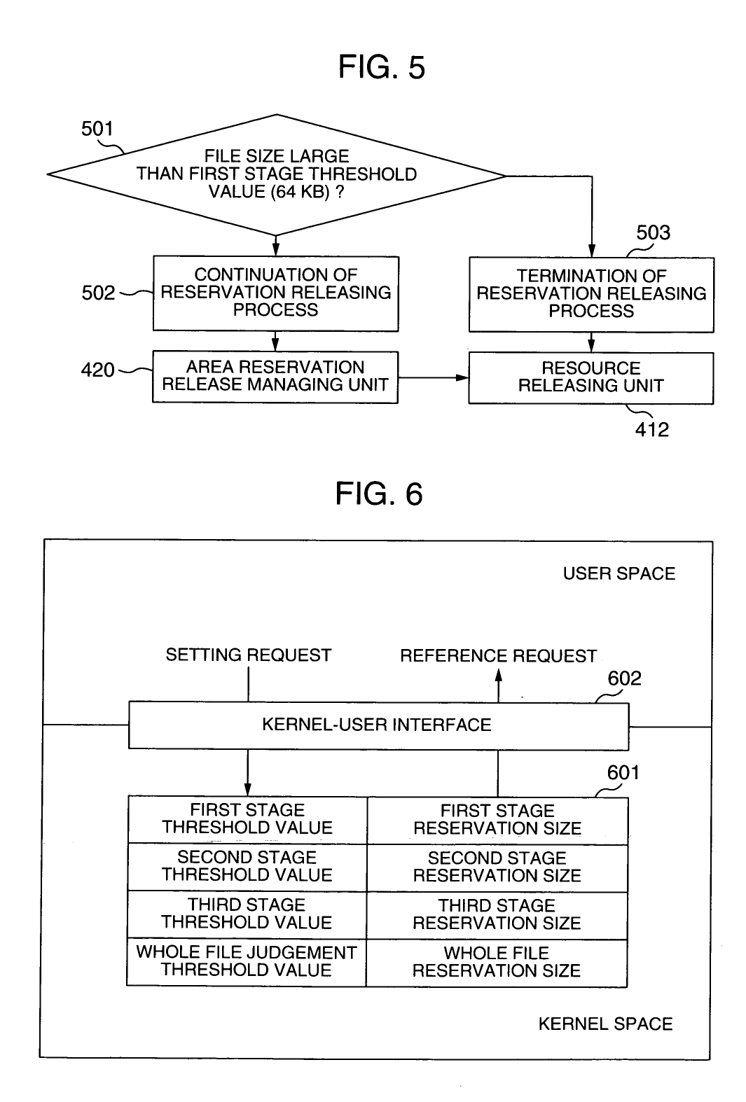

Next, with reference to FIG. 5, the contents of the process to be executed by the reservation area release determining unit 411 will be described. When the process is passed to the reservation area release determining unit 411, at 501 it is judged whether the file size is larger than the first stage threshold value (e.g., 64 KB). If the file size is large than the first stage threshold value, the process at 502 follows. At 502 the area reservation release managing unit 420 is requested to release the unused reservation area. After this area is released, the process is passed to the resource releasing unit 412 which releases resources such as a file descriptor to terminate the Close process.

If the condition at 501 is not satisfied, the process at 503 follows. At 503 in order to skip the reservation release process, the process at the resource releasing unit 412 follows without involvement of the process at the area reservation release managing unit 420, to thereafter terminate the Close process.

It is desired that the first stage threshold value described in the Close process is always coincident with the first stage threshold value at 105 shown in FIG. 1.

The above-described first stage threshold value, second stage threshold value, third stage threshold value, first stage reservation value, second stage reservation value, third stage reservation value, whole file judgement threshold value and whole file reservation size are determined in advance by default values. It is, however, desired that a user sets again in the system unit, in the file system unit, in the file unit and the like.

FIG. 6 is a block diagram showing an interface between a user and a kernel to be used when parameters used for determining the reservation size are set and referred. A table 601 used when the reservation size is determined as illustrated in FIG. 1 stores the first stage threshold value, second stage threshold value, third stage threshold value, first stage reservation value, second stage reservation value, third stage reservation value, whole file judgement threshold value and whole file reservation size. Default values are set in advance as the parameters of this table.

In the file system of this invention, in response to a setting request from a user space, the parameters in the table 601 can be replaced by using the interface 602 between the kernel and user. In response to a reference request from the user space, the current parameter values in the table 601 can be referred by using the interface 602 between the kernel and user. As the interface 602 between the kernel and user, the /proc/sys file system of Linux, ioctl of UNIX (registered trademark) or the like is used.

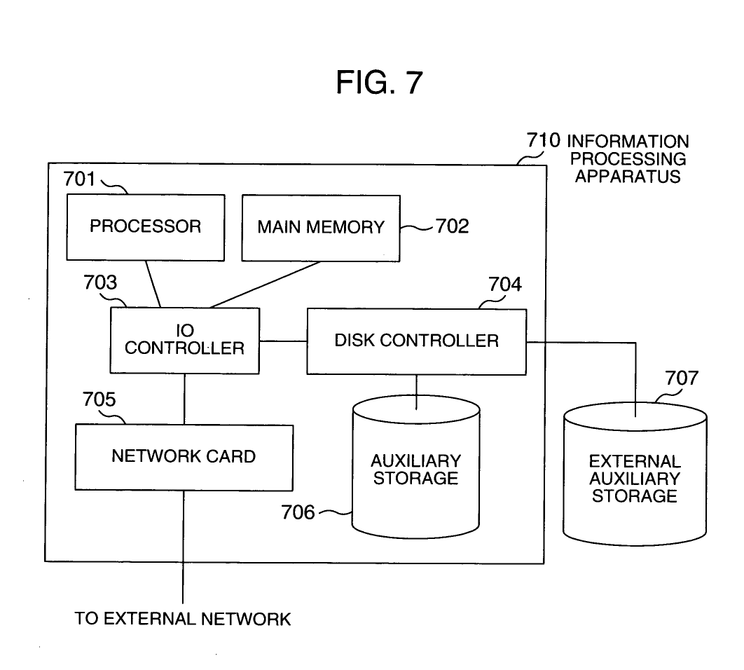

FIG. 7 is a diagram showing the structure of an embodiment of an information processing apparatus installing the file system of this invention. The information processing apparatus has a processor 701, a main memory 702, an IO controller 703, a disk controller 704, a network card 705 and an auxiliary storage 706. The IO controller 703 is connected to the processor 701, main memory 702, disk controller 704 and network card 705, and the disk controller 704 is connected to the auxiliary storage inside the apparatus and an external auxiliary storage 707 outside the apparatus. The network card 705 is connected to an external network such as a LAN. The file system of the invention runs on the information processing apparatus to input and output data to and from the auxiliary storage 706 and external auxiliary storage 707.

According to the invention, a file system can be realized which can prevent excessive reservation operations, reduce the process cost of the area release and effectively prevent fragment generation. Accordingly, this file system can be applied widely to information processing apparatuses equipped with a disk storage.

It should be further understood by those skilled in the art that although the foregoing description has been made on embodiments of the invention, the invention is not limited thereto and various changes and modifications may be made without departing from the spirit of the invention and the scope of the appended claims.

1. A file system capable of reserving a write area, wherein when a file write process is performed, a file size or a file offset of a file to be written is compared with a threshold value designated in advance, and in accordance with a comparison result, a reservation size of a write area is changed.

2. The file system according to claim 1, wherein when the file write process is performed and if the file size or the file offset of the file to be written is equal to or larger than the threshold value designated in advance, reservation is performed at a reservation size designated in advance, and if the file size or the file offset is smaller than the threshold value, reservation is performed at a write request size.

3. The file system according to claim 2, wherein if the reservation at said reservation size is failed due to an insufficient file system area, reservation is again performed at the write request size.

4. The file system according to claim 2, wherein when an unused area of a reserved area is released and if a file size of a file to be released is smaller than a threshold value designated in advance, a release process is intercepted, whereas if the file size is equal to or larger than the designated threshold value, the release process is continued.

5. The file system according to claim 2, wherein a plurality of threshold values of a file size and a plurality of reservation files corresponding to said threshold values are designated, and if the file size of a file to be written does not reach any one of said threshold values, reservation is performed at the write request size, whereas if the file size of the file to be written reaches any one of said threshold values, reservation is performed at the reservation size corresponding to the hit threshold value.

6. The file system according to claim 5, wherein when an unused area of a reserved area is released and if a file size of a file to be released is smaller than a smallest threshold value among said plurality of threshold values, a release process is intercepted, whereas if the file size is equal to or larger than the smallest threshold value, the release process is continued.

7. The file system according to claim 1, wherein if a write start offset is equal to or larger than a sum of the file size of the file to be written and a value designated in advance, reservation is performed at the write request size or a second reservation size different from said reservation size designated in advance.

8. A kernel-user interface according to claim 1, wherein when a user designates a value, said value is reflected upon a corresponding field of a table where the threshold values and reservation sizes used by the file system are stored.

9. A kernel-user interface according to claim 1, wherein a user can refer to values in a table where the threshold values and reservation sizes used by the file system are stored.

10. An information processing apparatus according to claim 1, comprising a processor, a main memory, an I/O controller, a disk controller, an auxiliary storage and a network card, the information processing apparatus installing the file system.

11. A file write method wherein a storage area of a storage is managed in a block unit having a constant size, and in response to a write request of a file, a reservation operation is performed to set a write reservation size or a write reservation block of the file to sequentially perform a write process, the file write method comprises:
a first judgement procedure of comparing a file offset of the file to be written with a threshold value designated in advance for the file offset; and
a second judgement procedure of comparing a file size of the file to be written with a threshold value designated in advance for the file size,
said reservation operation is executed at a first reservation size designated in advance, if said first judgement procedure judges that the threshold value is hit, said reservation operation is executed at a second reservation size designated in advance, if said second judgement procedure judges that the threshold value is hit, and said reservation operation is executed at a write request size if both said first and second judgement procedures do not hit the threshold values.
